(19) United States
(12) Patent Application Publication
(10) Pub. No.: US 2012/0127268 A1
(43) Pub. Date: May 24, 2012

(54) METHOD AND APPARATUS FOR CONTROLLING BROADCASTING NETWORK AND HOME NETWORK FOR 4D BROADCASTING SERVICE

(75) Inventors: Jae Kwan YUN, Daejeon (KR); Jong Hyun JANG, Daejeon (KR); Kyeong Deok MOON, Daejeon (KR); Kwang Roh PARK, Daejeon (KR); Chae Kyu KIM, Daejeon (KR)

(73) Assignee: Electronics and Telecommunications Research Institute, Daejeon (KR)

(21) Appl. No.: 13/299,719

(22) Filed: Nov. 18, 2011

(30) Foreign Application Priority Data
Nov. 19, 2010 (KR) 10-2010-0115687

(51) Int. Cl. H04N 13/00; H04N 21/242; H04N 21/80

(52) U.S. Cl. 348/43; 725/116; 725/82; 348/E13.025; 348/E13.062; 348/E13.071

(57) ABSTRACT

Disclosed are a method and an apparatus for controlling a broadcasting network and a home network for a 4D broadcasting service. The method for controlling a broadcasting network for a 4D (four-dimension) broadcasting service according to an exemplary embodiment of the present invention includes: encoding image data of a predetermined place photographed by multiple cameras; receiving realistic effect data from at least one sensor sensing state information of the predetermined place while the photographing is performed; synchronizing the realistic effect data and the image data with each other by considering an encoding time of the image data; generating a transport stream (TS) including the realistic effect data and the image data based on the synchronization; and transmitting the generated TS to a home network.

### CROSS-REFERENCE TO RELATED APPLICATIONS

This application claims priority to and the benefit of Korean Patent Application No. 10-2010-0115687 filed in the Korean Intellectual Property Office on Nov. 19, 2010, the entire contents of which are incorporated herein by reference.

### TECHNICAL FIELD

The present invention relates to 4D (four-dimension) broadcasting technology. More particularly, an exemplary embodiment of the present invention relates to a method and an apparatus for controlling a broadcasting network and a home network for a 4D broadcasting service.

### BACKGROUND

With recent technological development, solutions that implement 3D contents in a broadcasting receiver have been developed. Representative examples of methods of providing 3D contents include a glass type and a non-glass type. Furthermore, as more detailed methods for implementing a non-glass type 3D TV, parallax barrier technology and lenticular technology have been discussed.

In the parallax barrier, numerous bars are erected in a display device so as not to view each channel according to eyes. That is, at a predetermined viewpoint, a left image is hidden with respect to a right eye and a right image is hidden with respect to a left eye.

Meanwhile, the lenticular uses a stereoscopic picture postcard and a transparent uneven film is plated on the stereoscopic picture postcard and left and right images are refracted and sent by arranging a small lens in a display.

However, in the case of 3D technology discussed up to now, only improvement of a 3D effect of an image has been primarily focused, and a study of processing realistic effect data related to 3D images and development of a solution have been insufficient.

### SUMMARY

The present invention has been made in an effort to provide a protocol and a device of a network capable of more accurately and rapidly processing realistic effect data related to 3D images.

An exemplary embodiment of the present invention provides a method for controlling a broadcasting network for a 4D (four-dimension) broadcasting service, the method including: encoding image data of a predetermined place photographed by multiple cameras; receiving realistic effect data from at least one sensor sensing state information of the predetermined place while the photographing is performed; synchronizing the realistic effect data and the image data with each other by considering an encoding time of the image data; generating a transport stream (TS) including the realistic effect data and the image data based on the synchronization; and transmitting the generated TS to a home network.

Another exemplary embodiment of the present invention provides a method for controlling a home network for a 4D broadcasting service, the method including: receiving a TS including image data of a predetermined place photographed by the multiple cameras and realistic effect data received from at least one sensor sensing state information of the predetermined place; transmitting a first area corresponding to the image data in the received TS to an image processor; transmitting a second area corresponding to the realistic effect data in the received TS to a realistic effect data analyzing module; and transmitting a command signal depending on the realistic effect data analyzed by the realistic effect data analyzing module to a corresponding device of the home network.

Yet another exemplary embodiment of the present invention provides a broadcasting server of a broadcasting network, the server including: a first receiving module receiving encoded image data from an encoder encoding image data of a predetermined place photographed by multiple cameras; a second receiving module receiving realistic effect data from at least one sensor sensing state information of the predetermined place while the photographing is performed; a synchronization module synchronizing the realistic effect data and the image data with each other by considering an encoding time of the image data; a TS generating module generating a transport stream (TS) including the realistic effect data and the image data based on the synchronization; and a transmission module transmitting the generated TS to a home network.

Still another exemplary embodiment of the present invention provides control device of a home network, the device including: a receiving module receiving a TS including image data of a predetermined place photographed by the multiple cameras and realistic effect data received from at least one sensor sensing state information of the predetermined place; an image processor processing a first area corresponding to the image data in the received TS; a realistic effect data analyzing module processing a second area corresponding to the realistic effect data in the received TS; and a transmission module transmitting a command signal depending on the realistic effect data analyzed by the realistic effect data analyzing module to a corresponding device of the home network.

According to the exemplary embodiments of the present invention, a realistic effect which the existing broadcasting media cannot provide can be reproduced by adding realistic effect information required to apply a realistic service, and the like to the existing broadcasting media including a moving picture, audio, and texts.

Further, according to the exemplary embodiments of the present invention, a service having more improved reality can be provided generating realistic effect information related to 3D images in link with information at the time of actually photographing images.

Besides, according to the exemplary embodiments of the present invention, related data can be processed by one sequence by generating a realistic effect in which a lot of data are generated in a short time, such as motions of people, and the like in real time by using an aggregator.

### BRIEF DESCRIPTION OF THE DRAWINGS

FIG. 1 is a diagram wholly showing a broadcasting network and a home network for a 4D broadcasting service according to an exemplary embodiment of the present invention;

FIG. 2 is a diagram more specifically showing components of a network shown in FIG. 1;

FIG. 3 is a diagram showing metadata related to a realistic effect (e.g., a temperature effect) according to an exemplary embodiment of the present invention;

FIG. 4 is a diagram showing a first process of process data for a 4D broadcasting service according to an exemplary embodiment of the present invention;

FIG. 5 is a diagram showing a second process of process data for a 4D broadcasting service according to an exemplary embodiment of the present invention;

FIG. 6 is a diagram showing a third process of process data for a 4D broadcasting service according to an exemplary embodiment of the present invention;

FIGS. 7 and 8 are diagrams more specifically showing metadata related to a realistic effect according to an exemplary embodiment of the present invention;

FIG. 9 is a block diagram more specifically showing a broadcasting server and a control device for a 4D broadcasting service according to an exemplary embodiment of the present invention;

FIG. 10 is a diagram showing a process in which the control device shown in FIG. 9 controls a first device connected to a home network;

FIG. 11 is a diagram showing a process in which the control device shown in FIG. 9 controls a second device connected to a home network;

FIG. 12 is a diagram showing a process in which the control device shown in FIG. 9 controls a third device connected to a home network;

FIG. 13 is a diagram showing a process in which the control device shown in FIG. 9 controls a fourth device connected to a home network;

FIG. 14 is a flowchart wholly showing a control method for a 4D broadcasting service according to an exemplary embodiment of the present invention; and

FIG. 15 is a diagram more specifically showing operation S1410 shown in FIG. 14 according to another exemplary embodiment of the present invention.

### DETAILED DESCRIPTION

In exemplary embodiments described below, components and features of the present invention are combined with each other in a predetermined pattern. Each component or feature may be considered to be optional unless stated otherwise. Each component or feature may not be combined with other components or features. Further, some components and/or features are combined with each other to configure the exemplary embodiments of the present invention. The order of operations described in the exemplary embodiments of the present invention may be modified. Some components or features of any exemplary embodiment may be included in other exemplary embodiments or substituted with corresponding components or features of other exemplary embodiments.

The exemplary embodiments of the present invention may be implemented through various means. For example, the exemplary embodiments of the present invention may be implemented by hardware, firmware, software, or combinations thereof.

In the case of implementation by hardware, a method according to the exemplary embodiment of the present invention may be implemented by application specific integrated circuits (ASICs), digital signal processors (DSPs), digital signal processing devices (DSPDs), programmable logic devices (PLDs), field programmable gate arrays (FPGAs), a processor, a controller, a microcontroller, a microprocessor, and the like.

In the case of implementation by firmware or software, the method according to the exemplary embodiments of the present invention may be implemented in the form of a module, a process, or a function of performing the functions or operations described above. Software codes may be stored in a memory unit and driven by a processor. The memory unit is positioned inside or outside of the processor to transmit and receive data to and from the processor by a previously known various means.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

Further, term “module”, etch described in the specification imply a unit of processing a predetermined function or operation and can be implemented by hardware or software or a combination of hardware and software.

Predetermined terms used in the following description are provided to help understanding the present invention and the use of the predetermined terms may be modified into different forms without departing from the spirit of the present invention.

Hereinafter, embodiments of the present invention will be described with reference to the accompanying drawings. In describing the present invention, well-known functions or constructions will not be described in detail since they may unnecessarily obscure the understanding of the present invention. In addition, terms described below as terms defined by considering their functions in the present invention may be changed depending on a user or operator's intention or a convention. Therefore, the definitions should be made on the basis of overall contents of the specification.

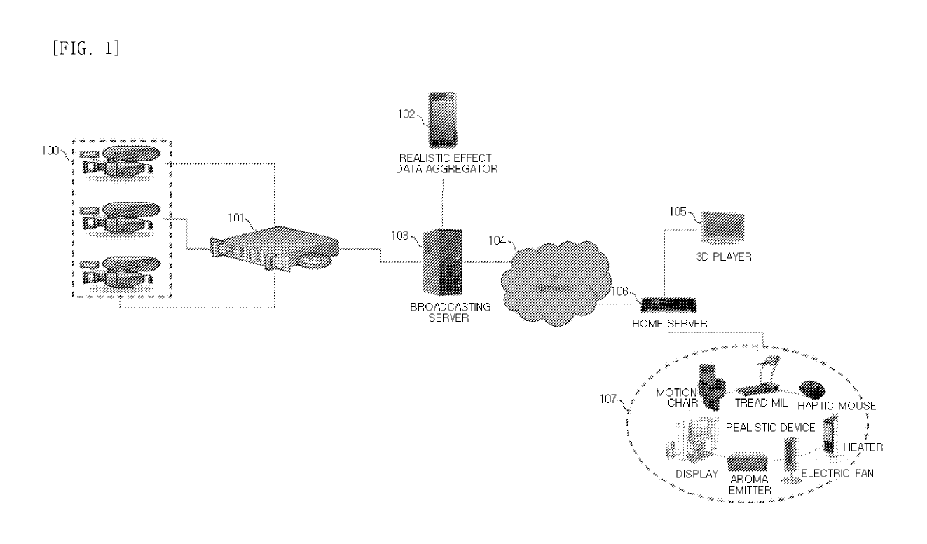

FIG. 1 is a diagram wholly showing a broadcasting network and a home network for a 4D broadcasting service according to an exemplary embodiment of the present invention. Hereinafter, referring to FIG. 1, a broadcasting network and a home network for a 4D broadcasting service according to an exemplary embodiment of the present invention will be wholly described below.

According to the exemplary embodiment of the present invention, while actually recording broadcasts such as movies, dramas, and the like by using a 3D camera, environmental information, motion information, and realistic information are automatically acquired by using a sensor installed at a place where images are acquired or a mobile sensor and added to the images in real time. In contrast, when realistic effect data related to a place where a 3D image is acquired is fully separated from a process of acquiring the 3D image, a user cannot perfectly receive a situation or feeling of the place where the 3D image is photographed. Therefore, the technology of converting the image inputted from the 3D camera into a broadcasting media format, the aggregator technology for collecting the realistic effect, the technology for storing the image and the realistic effect into a broadcasting format, MPEG-2 TS, the technology of transmitting the realistic effect synchronized with the image, the technology of extracting the image and the realistic effect from a home server, the technology of verifying the realistic effect in a simulator, and the technology of reproducing the realistic effect by using an actual realistic device will be more specifically described below.

As shown in FIG. 1, audio/video data related to the 3D image are acquired using at least two multiple cameras 100. Further, the acquired audio/video data are encoded using a network video server (NVS) 101. The NVS 101 may receive, for example, an SD-level image by using a component cable or receive an HD-level image by using an HDMI cable. The NVS 101 transfers the encoded image to a broadcasting server 103 by using a wired or wireless network.

Further, while photographing using the multiple cameras 100 are in progress, an aggregator 102 for collecting realistic effect data collects circumferential information and converts the collected circumferential information into an XML format to transmit the converted XML-format to the broadcasting server 103. However, the circumferential information is acquired by using a sensor for acquiring, for example, a temperature, humidity, illumination, acceleration, angular velocity, gas, wind velocity, and positional information.

Furthermore, the broadcasting server 103 performs a synchronization operation in order to match collected realistic information with a reproduction time of an image. Experimentally, since an encoding time of image data is long and the realistic effect is collected by the sensor within a relatively short time, the synchronization operation is performed by delaying the time of the realistic effect to a predetermined range in time for the reproduction time of the image. The synchronized data is converted into an MPEG-4 which is a storage format.

A moving picture encoded into MPEG-4 is again encoded into the MPEG-2 TS format by using an MPEG-4 over MPEG-2 TS encoder for a broadcasting service. Thereafter, the moving picture encoded into the MPEG-2 TS format is multicasted to an IP network 104 by using a UDP/IP. Meanwhile, in the above description, the MPEG-4 and the MPEG-2 have been described as an example, but the present invention is not necessarily limited thereto and data having different formats may be used.

A home server 106 receives multicasted broadcasting contents by using a UDP/IP receiver and thereafter, removes a header of TS by using an MPEG-2 TS demux. Furthermore, during this process, the 3D image is transmitted to a 3D player 105 and the realistic effect data is transmitted to a corresponding device 107 to be reproduced in synchronization with the 3D image. In particular, the corresponding device 107 corresponds to a device that can process metadata related with the realistic effect transmitted from the broadcasting server 103 and for example, may be an aroma emitter, an LED, a curtain, a bubble generator, a tickler, an electric fan, a heater, a haptic mouse, a tread mill, a motion chair, a display, or the like.

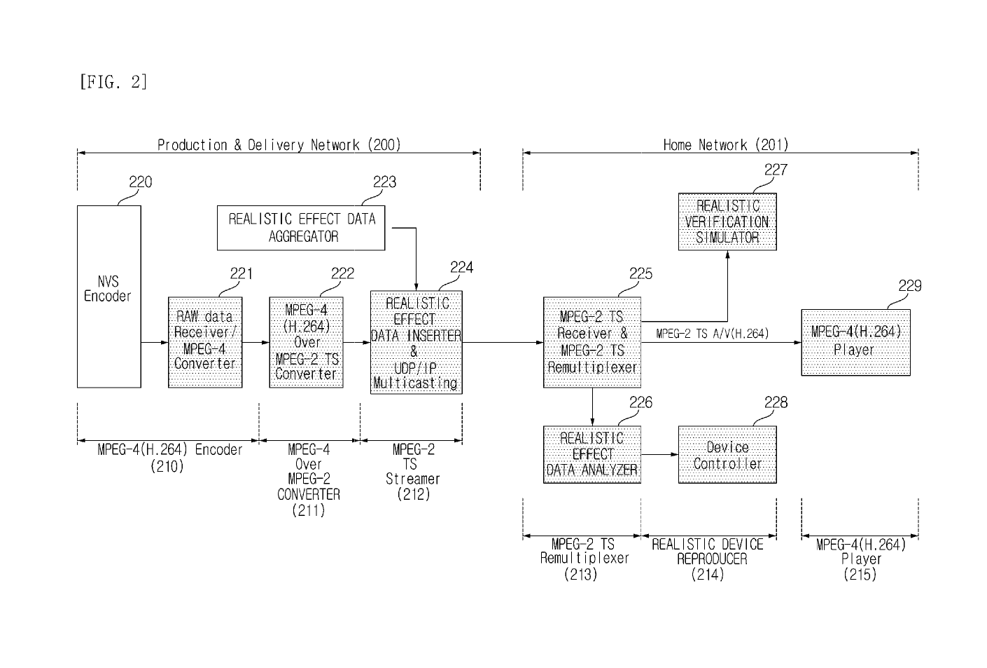

FIG. 2 is a diagram more specifically showing components of a network shown in FIG. 1. Hereinafter, referring to FIG. 2, the components of the network shown in FIG. 1 will be more specifically described.

As shown in FIG. 2, a system according to an exemplary embodiment of the present invention includes a production & delivery network 200 and a home network 201.

The production & delivery network 200 is a component that acquires the 3D image and the realistic effect and the home network 201 is a component that receives and reproduces the 3D image and the realistic effect.

Furthermore, the production & delivery network 200 may include an MPEG-4(H.264) encoder 210, an MPEG-4 over MPEG-2 TS converter 211, and an MPEG-2 TS streamer 212. Further, the home network 201 may include an MPEG-2 TS remultiplexer 213, a realistic device reproducer 214, and an MPEG-4(H.264) player 215.

More specifically, an NVS encoder 220 is an encoder for converting an analog image photographed by using a 2D camera or 3D camera into a digital image and an image outputted from the NVS encoder 220 is transmitted to a raw data receiver 221 of the broadcasting server 221. The raw data receiver 221 converts the received raw data into MPEG-4 data. However, the MPEG-4 data needs to be converted into the MPEG-2 TS again in order to be multicasted to the home network. An MPEG-4(H.264) over MPEG-2 TS converter 222 converts the MPEG-4 file into the MPEG-2 TS.

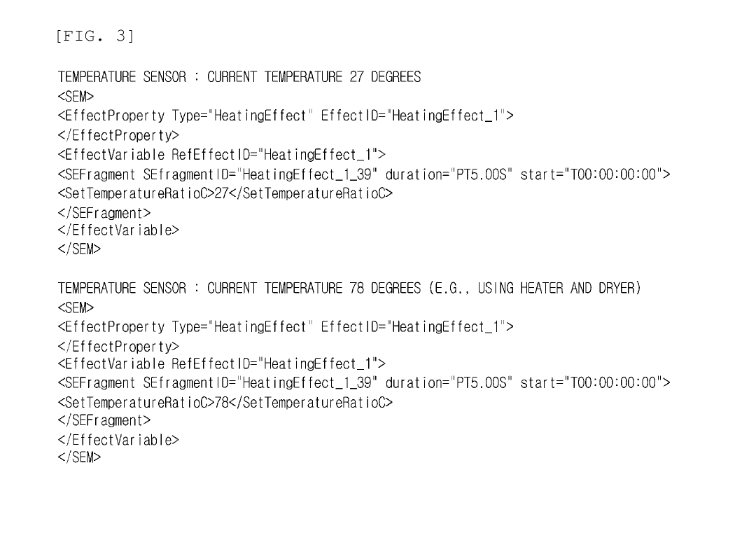

Meanwhile, a realistic effect data aggregator 223 collects the realistic effect by using the sensor and converts the collected realistic effect into XML-type metadata. One detailed example of the realistic effect metadata is shown in FIG. 3. In particular, in FIG. 3, realistic effect data related to temperature sensed by a temperature sensor is shown in the XML type. However, numerical values are merely examples and the scope of the present invention is not limited thereto.

According to the exemplary embodiment of the present invention, the production & delivery network 200 transfers values sensed by the sensor to the home network 201. Furthermore, at the side of the home network 201, current temperatures of the home network and a home where the home network is installed need to be recorded in order to process the XML data of FIG. 3 received from the production & delivery network 200. Accordingly, by comparing the current temperature of the home with a temperature corresponding to the XML data received from the production & delivery network 200, the temperature of the home is controlled to reach the corresponding temperature. Such a control may be implemented by controlling relevant devices (an air-conditioner, an electric fan, a heater, and the like).

The sensor effect metadata collected from the realistic effect data aggregator 223 is combined to the MPEG-2 TS like the image through a realistic effect data inserter & UDP/IP multicasting module 224. Further, the realistic effect data inserter & UDP/IP multicasting module 224 multicasts the combined MPEG-2 TS to the home network 201.

The data transmitted to the home network 201 is received by, particularly, an MPEG-2 TS receiver & MPEG-2 TS remultiplexer 225. The received MPEG-2 TS is separated into the 2D or 3D image and the realistic effect data, which are each transferred to an MPEG-4(H.264) player 229, a realistic verification simulator 227, and a realistic effect data analyzer 226.

The realistic effect data analyzer 226 analyzes the transmitted realistic effect and converts the realistic effect into the corresponding device control code, and thereafter, sends a control command to a device controller 228.

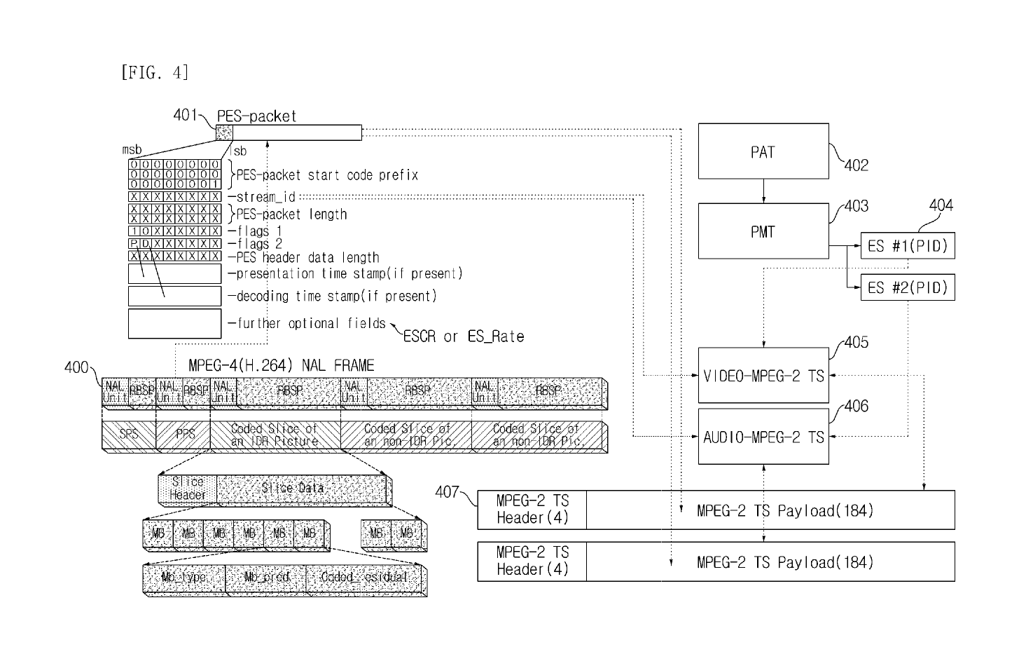

FIG. 4 is a diagram showing a first process of process data for a 4D broadcasting service according to an exemplary embodiment of the present invention. Hereinafter, referring to FIG. 4, in the case where the data transmitted from the NVS is an MPEG-4 network abstraction layer (NAL) frame, a process of converting the corresponding data into the MPEG-2 TS will be described below.

The data which can be inputted into the NVS may include, for example, data or MPEG-4 NAL. The data may be converted into its own format, while the MPEG-4 NAL format needs to be processed as shown in FIG. 4.

In the case where an MPEG-4(H.264) NAL frame 400 is inputted in the NVS, a program association table (PAT) 402 and a program map table ( ) 403 of the MPEG-2 TS type are generated by referring to a packetized elementary stream-packet (PES-packet) in the frame.

That is, stream_ID in the PES-packet is analyzed, and audio and video are distinguished from each other to generate and insert a stream information descriptor of an elementary stream (ES) 404. In addition, in generating the stream information descriptor, predetermined PID information is allocated and converted into the MPEG-2 TS. In this case, the audio configures an AUDIO-MPEG-2 TS 406, which is stored in a payload of the MPEG-2 TS and the video configures a VIDEO-MPEG-2 TS 405, which is stored in the payload of the MPEG-2 TS. Information thereon is stored in an MPEG-2 TS header 407.

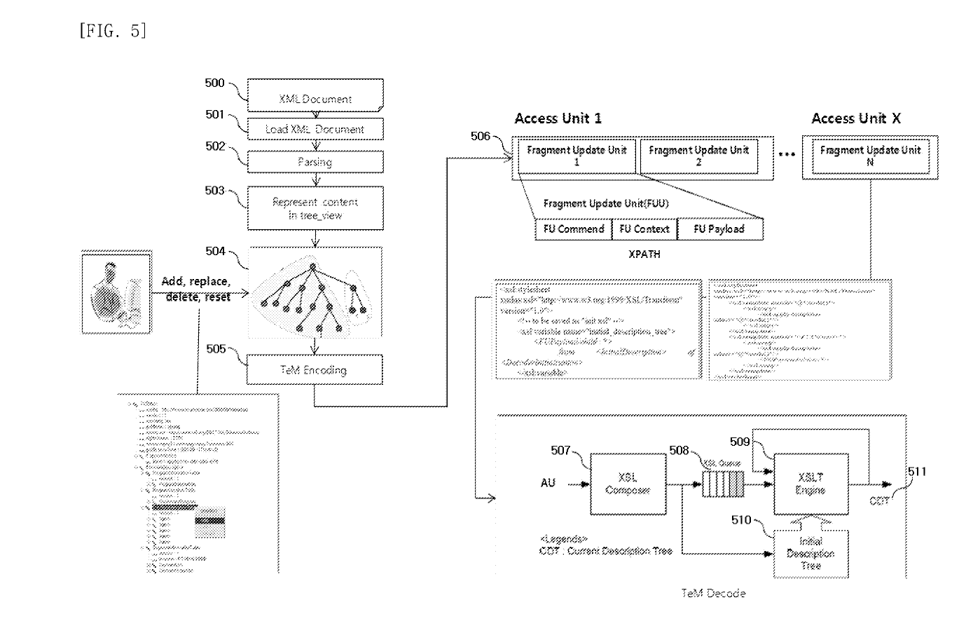

FIG. 5 is a diagram showing a second process of process data for a 4D broadcasting service according to an exemplary embodiment of the present invention. Hereinafter, referring to FIG. 5, a process associated with encoding and decoding for transmitting realistic effect metadata used in real-time broadcasting will be described below.

As shown in FIG. 5, first, a document configured by an XML 500 is loaded (S501). Thereafter, it is parsed whether the document is a normal schema (S502) and the corresponding XML document is displayed in a tree form (S503). Thereafter, the XML document is edited according to requests (e.g., ADD, DEL, REPLACE, and the like) from a user (S504) and an XML document transmitted to a home server together with positional information of a corresponding node is generated (S505).

Furthermore, when the XML document is generated according to the above process, the XML document is packetized to a form of an access unit (AU) 506 to be transmitted to an MPEG-2 TS. The packetized AU is subjected to an MPEG-2 Private Section, which is stored in the MPEG-2 TS. The MPEG-2 TS stored through such a process is transmitted by using a UDP/IP communication.

The server receives the MPEG-2 TS and thereafter, identifies texture format for multimedia description streams (TeM). In addition, the private section of the MPEG-2 TS is configured to the AU packet again and thereafter, the AU is stacked on an XSL queue 508 through an XSL composer 507. Thereafter, the AU is compared with an initial description tree 510 stored in the home server by using an XSLT engine 509 and thereafter, a changed description tree (CDT) 511 is configured and a changed part is transmitted to a relevant device. The relevant device may be diverse devices in a home network, which are controlled by the home server.

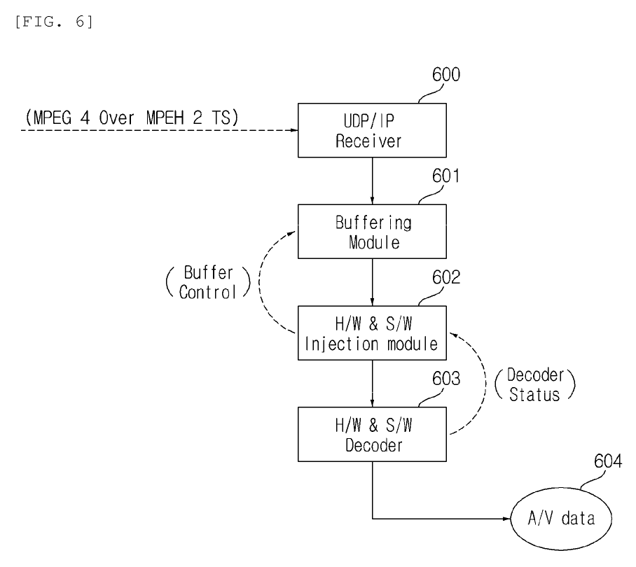

FIG. 6 is a diagram showing a third process of process data for a 4D broadcasting service according to an exemplary embodiment of the present invention. Hereinafter, referring to FIG. 6, a process for processing a 3D image will be described below.

As shown in FIG. 6, an MPEG-4 over MPEG-2 TS stream transmitted through a UDP/IP multicast is received by a UDP/IP receiver 600. Further, the received stream is buffered through a buffer 601. In addition, the buffered stream is outputted to an audio/video 604 through an H/W injection and S/W injection module 602 and an H/W decoder and S/W decoder 603.

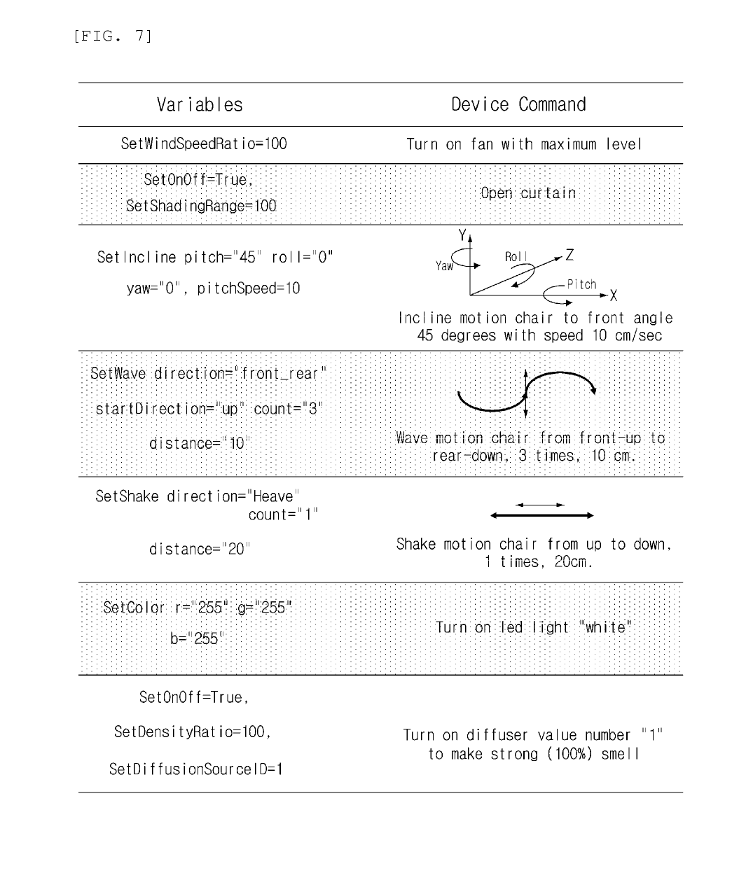

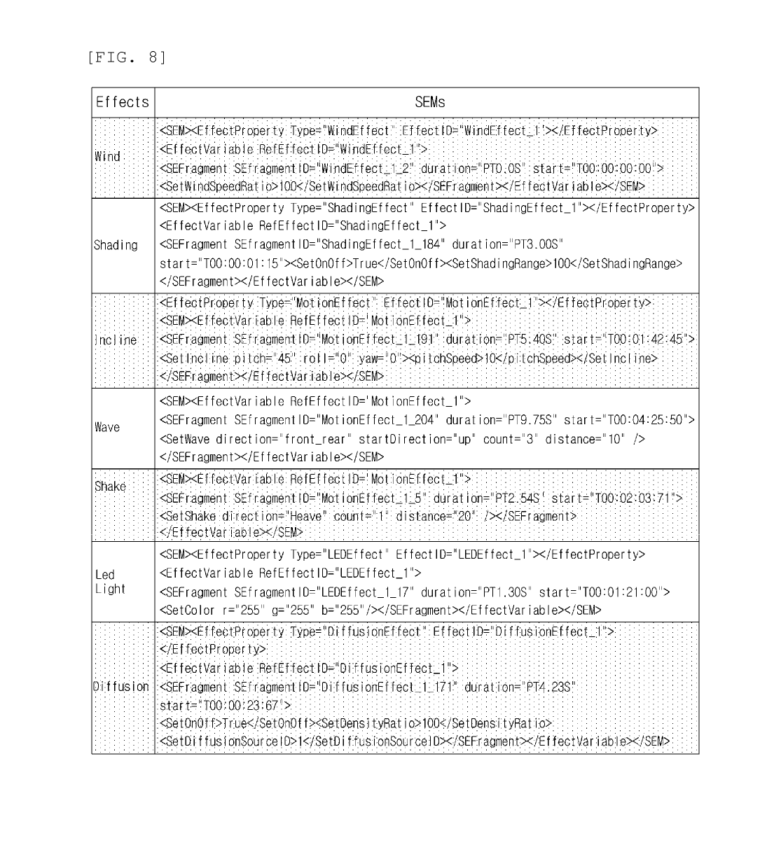

FIGS. 7 and 8 are diagrams more specifically showing metadata related to a realistic effect according to an exemplary embodiment of the present invention. Referring to FIGS. 7 and 8, metadata related with a realistic effect for realistic broadcasting will be more specifically described below.

In FIG. 7, effect values associated with wind, illumination (curtain), motions (leaning, waving, and shaking), lighting, fragrance, or the like are expressed. Furthermore, in FIG. 8, the values shown in FIG. 7 are displayed as realistic effect metadata. In FIG. 7, the wind is indicated as strong wind by expressing the intensity of wind as 100 and an opened state of the curtain is indicated by expressing a shading range of the curtain as 100. Meanwhile, in the case of the motions, leaning, waving, and shaking are expressed by using three types of pitch, yaw, and roll. Values of a red, a green, and a blue are expressed as the illumination and a serial number of defined fragrance is displayed as the fragrance. However, detailed numerical values thereof are merely examples and the scope of the present invention should be, in principal, determined by the appended claims.

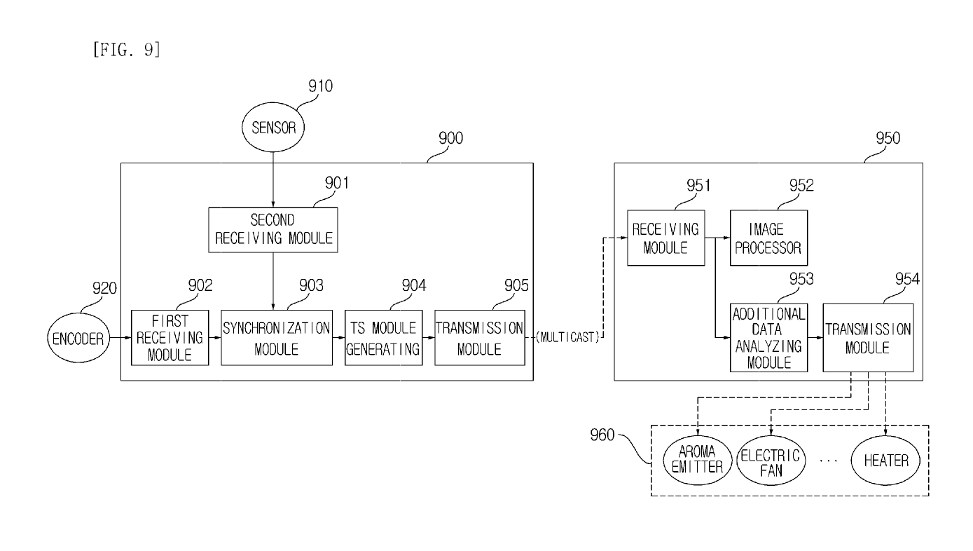

FIG. 9 is a block diagram more specifically showing a broadcasting server and a control device for a 4D broadcasting service according to an exemplary embodiment of the present invention. Hereinafter, referring to FIG. 9, a broadcasting server and a control device for a 4D broadcasting service according to an exemplary embodiment of the present invention will be more specifically described below. Further, referring to the descriptions of FIGS. 1 to 8, FIGS. 9 to 15 are modified or compensated for implementation within the scope of the present invention.

A broadcasting server 900 according to the exemplary embodiment of the present invention includes a first receiving module 902 receiving image data encoded by an encoder 920 encoding image data of a predetermined place photographed by multiple cameras. Further, the broadcasting server 900 further includes a second receiving module 901 receiving realistic effect data from at least one sensor 910 sensing state information of the predetermined place while the photographing is performed.

Furthermore, a synchronization module 903 of the broadcasting server 900 synchronizes the realistic effect data and the image data by considering an encoding time of the image data and a TS generating module 904 generates a TS including the realistic effect data and the image data based on the synchronization. In addition, a transmission module 905 of the broadcasting server 900 is designed to transmit the generated TS to a home network.

The encoder 920 corresponds to, for example, the NVS encoder 101 shown in FIG. 1 and the sensor 910 corresponds to, for example, the realistic effect data aggregator 102 shown in FIG. 1.

Meanwhile, a control device 950 of the home network according to the exemplary embodiment of the present invention includes a receiving module 9510 receiving a TS including image data of a predetermined place photographed by the multiple cameras and realistic effect data received from at least one sensor sensing state information of the predetermined place. The control device 950 of the home network corresponds to, for example, a home server or a broadcasting receiver.

Furthermore, the control device 950 further includes an image processor 952, a realistic effect data analyzing module 953, and a transmission module 954.

The image processor 952 processes a first area corresponding to the image data in the received TS and the realistic effect data analyzing module 953 processes a second area corresponding to the realistic effect data in the received TS.

In addition, the transmission module 954 transmits a command signal depending on the realistic effect data analyzed by the realistic effect data analyzing module 953 to a corresponding device 960 of the home network. The corresponding device 960 may be a predetermined electronic appliance that is connected to a home network to transmit and receive data, such as an aroma emitter, an electric fan, a heater, or the like.

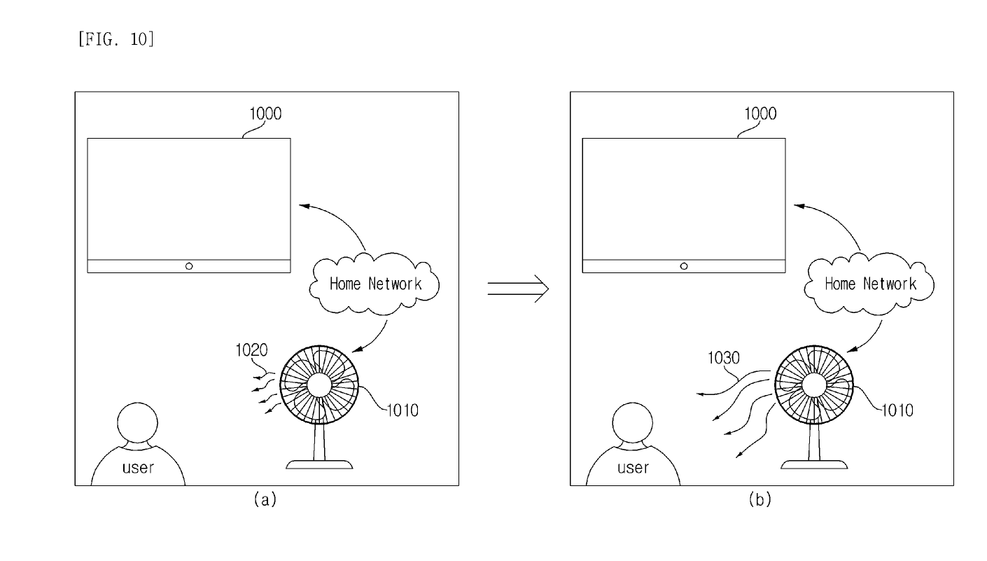

FIG. 10 is a diagram showing a process in which the control device shown in FIG. 9 controls a first device connected to a home network. Hereinafter, referring to FIG. 10, the process in which the control device controls the electric fan which is the first device connected to the home network will be described below.

As shown in FIG. 10A, it is assumed that a home server or a broadcasting receiver 1000 according to the exemplary embodiment of the present invention is connected to the electric fan 1010 positioned in a home through the home network and low wind intensity 1020 is outputted.

Meanwhile, in the case where the home server or broadcasting receiver 1000 receives realistic effect data (e.g., temperature related XML data) collected in real time at the time of photographing a 3D image from the broadcasting server, the electric fan 1010 is designed to output higher wind intensity 1030 according to a control command from the home server or broadcasting receiver 1000 as shown in FIG. 10B. That is, since the temperature related XML data is lower than a current temperature, the wind intensity of the electric fan is controlled to be higher in order to provide a similar temperature range as that at the time of photographing the 3D image to a user. Accordingly, according to the exemplary embodiment of the present invention, the user can experience a cool feeling at the time of photographing the 3D image as it is.

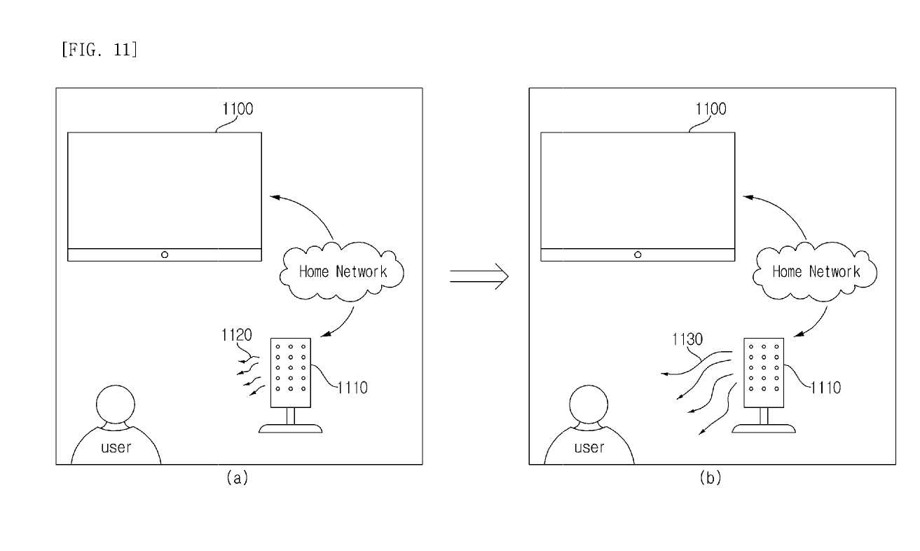

FIG. 11 is a diagram showing a process in which the control device shown in FIG. 9 controls a second device connected to a home network. Hereinafter, referring to FIG. 11, the process in which the control device controls the heater which is the second device connected to the home network will be described below.

As shown in FIG. 11A, it is assumed that a home server or a broadcasting receiver 1100 according to the exemplary embodiment of the present invention is connected to the heater 1110 positioned in the home through the home network and small heating amount 1120 is outputted.

Meanwhile, in the case where the home server or broadcasting receiver 1100 receives realistic effect data (e.g., temperature related XML data) collected in real time at the time of photographing the 3D image from the broadcasting server, the heater 1100 is designed to output larger heating amount 1130 according to the control command from the home server or broadcasting receiver 1110 as shown in FIG. 11B. That is, since the temperature related XML data is higher than the current temperature, the heating amount of the heater is controlled to be larger in order to provide the similar temperature range as that at the time of photographing the 3D image. Accordingly, according to the exemplary embodiment of the present invention, the user can experience a warm feeling at the time of photographing the 3D image as it is.

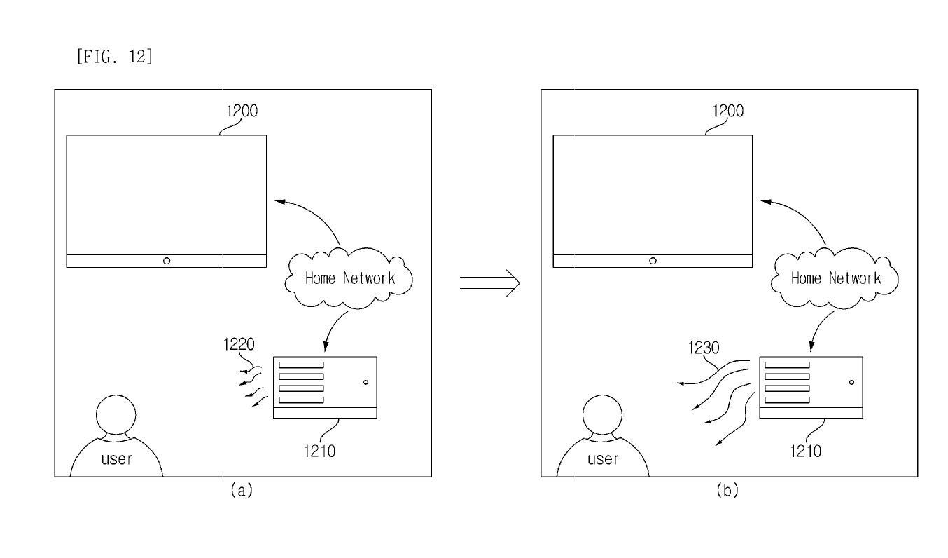

FIG. 12 is a diagram showing a process in which the control device shown in FIG. 9 controls a third device connected to a home network. Hereinafter, referring to FIG. 12, the process in which the control device controls the aroma emitter which is the third device connected to the home network will be described below.

As shown in FIG. 12A, it is assumed that a home server or a broadcasting receiver 1200 according to the exemplary embodiment of the present invention is connected to the aroma emitter 1210 positioned in the home through the home network and fragrance A 1220 is outputted.

Meanwhile, in the case where the home server or broadcasting receiver 1200 receives realistic effect data (e.g., fragrance related XML data) collected in real time at the time of photographing the 3D image from the broadcasting server, the aroma emitter 1210 is designed to output fragrance B 1230 according to the control command from the home server or broadcasting receiver 1200 as shown in FIG. 12B. Accordingly, according to the exemplary embodiment of the present invention, the user can experience fragrance similar as fragrance at the time of photographing the 3D image as it is.

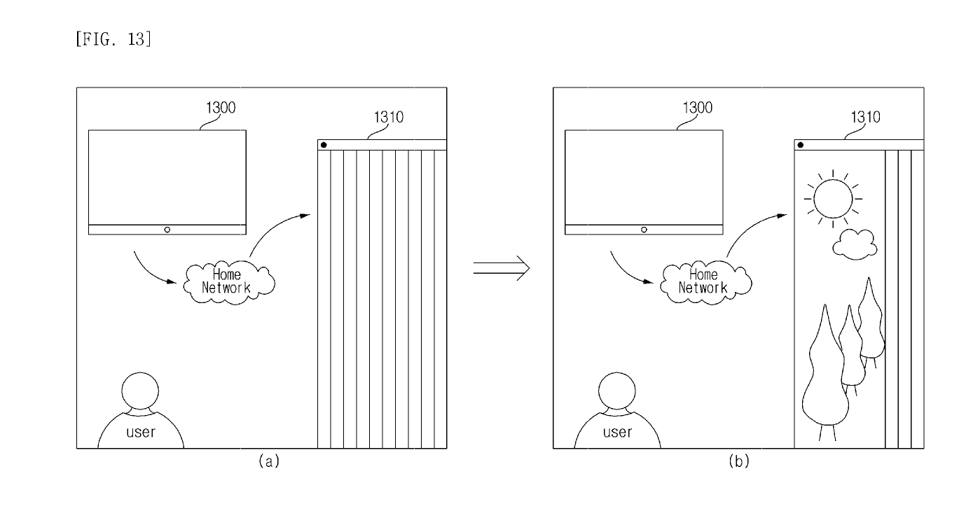

FIG. 13 is a diagram showing a process in which the control device shown in FIG. 9 controls a fourth device connected to a home network. Hereinafter, referring to FIG. 13, the process in which the control device controls the curtain which is the fourth device connected to the home network will be described below.

As shown in FIG. 13A, it is assumed that a home server or a broadcasting receiver 1300 according to the exemplary embodiment of the present invention is connected to the curtain 1310 positioned in the home through the home network and the entire curtain is closed.

Meanwhile, in the case where the home server or broadcasting receiver 1300 receives realistic effect data (e.g., contrast related XML data) collected in real time at the time of photographing the 3D image from the broadcasting server, the entire curtain 1310 is designed to be changed to an opened state according to the control command from the home server or broadcasting receiver 1310 as shown in FIG. 13B. Accordingly, according to the exemplary embodiment of the present invention, the user can experience a bright feeling or a dark feeling at the time of photographing the 3D image as it is.

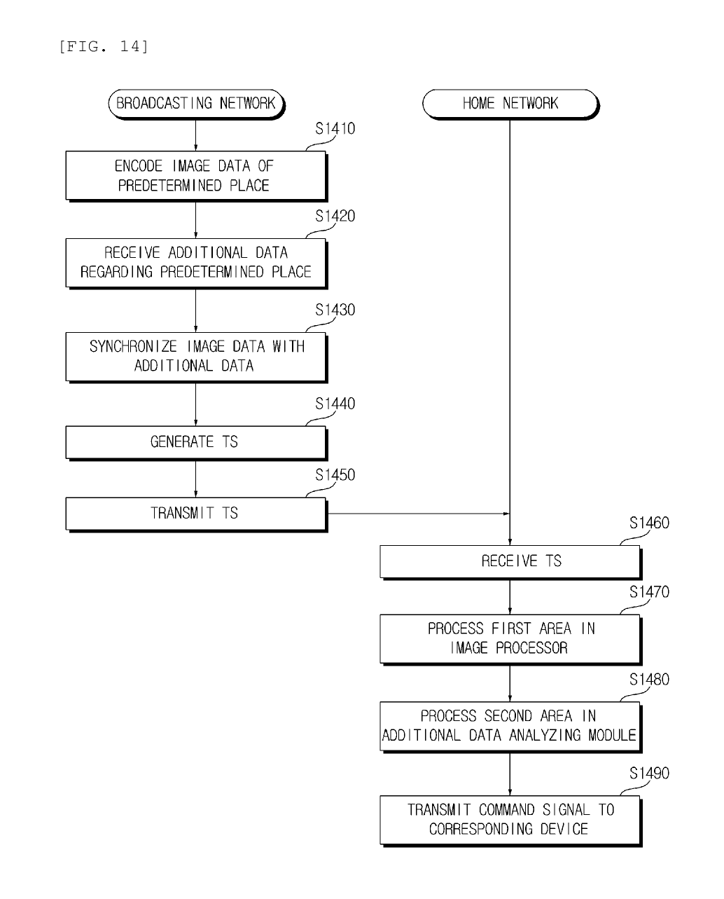

FIG. 14 is a flowchart wholly showing a control method for a 4D broadcasting service according to an exemplary embodiment of the present invention. Hereinafter, referring to FIG. 14, the control method for the 4D broadcasting service according to the exemplary embodiment of the present invention will be described below.

As shown in FIG. 14, a broadcasting network for a 3D (three-dimensional) broadcasting service encodes image data of a predetermined place photographed by multiple cameras (S1410). Furthermore, realistic effect data is received from at least one sensor sensing state information of the predetermined place while the photographing is performed (S1420). Further, the realistic effect data and the image data are synchronized by considering an encoding time of the image data (S1430).

Furthermore, a transport stream (TS) including the realistic effect data and the image data based on the synchronization is generated (S1440) and the generated TS is transmitted to a home network (S1450).

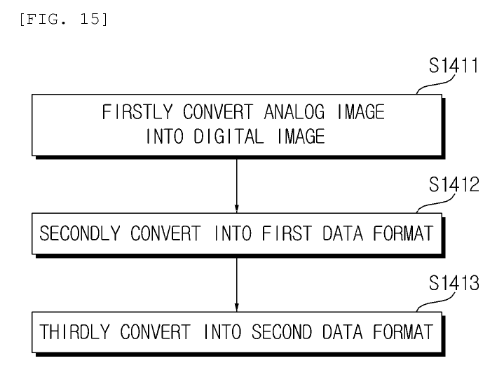

According to another exemplary embodiment of the present invention, as shown in FIG. 15, the operation S1410 further includes firstly converting an analog image photographed by using a 2D camera or 3D camera into a digital image (S1411), secondly converting raw data of the converted digital data into a first data format (S1412), and thirdly converting the converted first data format into a second data format (S1413).

Further, according to yet another exemplary embodiment of the present invention, operation S1430 includes delaying a synchronization timing of the realistic effect data by a required time by the first to third conversions. In addition, operation S1450 includes multicasting the TS generated in operation S1440 to a server of the home network on the basis of a UDP/IP.

In addition, the first data format corresponds to, for example, an MPEG-4 file format and the second data format corresponds to, for example, an MPEG-2 file format. The multiple cameras include, for example, a 2D camera and a 3D camera for a 3D service. Further, at least one sensor includes, for example, at least one of a temperature sensor, a wind velocity sensor, a positional information sensor, and a humidity sensor.

Meanwhile, in the control method of the home network for the 4D broadcasting service according to the exemplary embodiment of the present invention, a TS including image data of a predetermined place photographed by the multiple cameras and realistic effect data received from at least one sensor sensing state information of the predetermined place is received (S1460).

Furthermore, a first area corresponding to the image data in the received TS is transmitted to an image processor (S1470) and a second area corresponding to the realistic effect data in the received TS is transmitted to a realistic effect data analyzing module (S1480). In addition, a command signal depending on the realistic effect data analyzed by the realistic effect data analyzing module is transmitted to a corresponding device of the home network (S1490).

According to another exemplary embodiment of the present invention, operation S1460 includes receiving a TS in which encoded image data and realistic effect data sensed while the image data is photographed are synchronized from a broadcasting server.

The realistic effect data includes, for example, first data indicating a type of a predetermined device to be controlled among at least one device connected with the home network and second data indicating a function of the predetermined device, which are mapped. More specifically, for example, the realistic effect data may be designed as shown in FIG. 7. In addition, the first area and the second area are designed to be positioned, for example, in a payload of the TS.

As described above, according to the exemplary embodiment of the present invention, a realistic effect is not arbitrarily added to a corresponding moving picture after the photographing of the 3D image is completely terminated and editing of the photographed 3D image ends, but a situation at the time of actually photographing the 3D image included in the moving picture is transmitted to reproduce an effect that allows a user to feel that he/her is actually present at the place. Further, by applying this effect to a broadcast, media can be produced more effectively in fields to feel an actual situation, such as the news, a documentary, and the like.

As described above, the exemplary embodiments have been described and illustrated in the drawings and the specification. Herein, specific terms have been used, but are just used for the purpose of describing the present invention and are not used for defining the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. A method for controlling a broadcasting network for a 4D broadcasting service, the method comprising:
encoding image data of a predetermined place photographed by multiple cameras;
receiving realistic effect data from at least one sensor sensing state information of the predetermined place while the photographing is performed;
synchronizing the realistic effect data and the image data by considering an encoding time of the image data;
generating a transport stream (TS) including the realistic effect data and the image data based on the synchronization; and
transmitting the generated TS to a home network.

2. The method of claim 1, wherein the encoding of the image data includes:
firstly converting an analog image photographed by using a 2D camera or 3D camera into a digital image;
secondly converting raw data of the converted digital data into a first data format; and
thirdly converting the converted first data format into a second data format.

3. The method of claim 2, wherein the synchronizing includes delaying a synchronization timing of the realistic effect data by a required time by the first to third conversions.

4. The method of claim 2, wherein the first data format corresponds to an MPEG-4 file format and the second data format corresponds to an MPEG-2 file format.

5. The method of claim 1, wherein the transmitting to the home network includes multicasting the generated TS to a server of the home network on the basis of a UDP/IP.

6. The method of claim 1, wherein the multiple cameras include a 2D camera and a 3D camera for a 3D service.

7. The method of claim 1, wherein at least one sensor includes at least one of a temperature sensor, a wind velocity sensor, a positional information sensor, and a humidity sensor.

8. A method for controlling a home network for a 4D broadcasting service, the method comprising:
receiving a TS including image data of a predetermined place photographed by the multiple cameras and realistic effect data received from at least one sensor sensing state information of the predetermined place;
transmitting a first area corresponding to the image data in the received TS to an image processor;
transmitting a second area corresponding to the realistic effect data in the received TS to a realistic effect data analyzing module; and
transmitting a command signal depending on the realistic effect data analyzed by the realistic effect data analyzing module to a corresponding device of the home network.

9. The method of claim 8, wherein the receiving of the TS includes receiving a TS in which encoded image data and realistic effect data sensed while the image data is photographed are synchronized from a broadcasting server.

10. The method of claim 8, wherein the realistic effect data includes first data indicating a type of a predetermined device to be controlled among at least one device connected with the home network and second data indicating a function of the predetermined device, which are mapped.

11. The method of claim 8, wherein the receiving of the TS includes receiving the TS through a multicasting scheme on the basis of a UDP/IP.

12. The method of claim 8, wherein the first area and the second area are designed to be positioned in a payload of the TS.

13. A broadcasting server of a broadcasting network, the server comprising:
a first receiving module receiving encoded image data from an encoder encoding image data of a predetermined place photographed by multiple cameras;
a second receiving module receiving realistic effect data from at least one sensor sensing state information of the predetermined place while the photographing is performed;
a synchronization module synchronizing the realistic effect data and the image data by considering an encoding time of the image data;
a TS generating module generating a transport stream (TS) including the realistic effect data and the image data based on the synchronization; and
a transmission module transmitting the generated TS to a home network.

14. The broadcasting server of claim 13, wherein the encoder corresponds to a network video server (NVS) encoder.

15. A control device of a home network, the device comprising:
a receiving module receiving a TS including image data of a predetermined place photographed by the multiple cameras and realistic effect data received from at least one sensor sensing state information of the predetermined place;
an image processor processing a first area corresponding to the image data in the received TS;
a realistic effect data analyzing module processing a second area corresponding to the realistic effect data in the received TS; and
a transmission module transmitting a command signal depending on the realistic effect data analyzed by the realistic effect data analyzing module to a corresponding device of the home network.

16. The control device of claim 15, wherein the control device of the home network corresponds to a home server or a broadcasting receiver.
